(19) United States
(12) Patent Application Publication
(10) Pub. No.: US 2016/0332615 A1
(43) Pub. Date: Nov. 17, 2016

(54) CONTROL SYSTEM AND METHOD USING WEIGHT ESTIMATION OF HYBRID BUS

(71) Applicant: Hyundai Motor Company, Seoul (KR)

(72) Inventor: Se Joon Moon, Seoul (KR)

(21) Appl. No.: 14/929,262

(22) Filed: Oct. 31, 2015

(30) Foreign Application Priority Data
May 14, 2015 (KR) 10-2015-0067062

(51) Int. Cl. B60W 20/11; B60W 10/08; G06K 7/06; B60W 40/08; B60K 23/00; G01G 19/44; B60W 10/06; B60W 20/30

(52) U.S. Cl. CPC B60W 20/11; B60W 10/06; B60W 10/08; B60W 20/30; B60W 40/08; B60K 23/00; G01G 19/44; G06K 7/06; Y10S 903/902; B60W 2040/0872

(57) ABSTRACT

A system and method using weight estimation of a hybrid bus can estimate in real-time the entire weight of the hybrid bus according to the number of passengers using a transportation card reader in the hybrid bus, select a power distribution map and a transmission map according to the estimated entire weight of the hybrid bus, control a power split ratio of an engine and a motor by the selected map, and determine a transmission gear stage.

### CROSS-REFERENCE TO RELATED APPLICATION

This application claims under 35 U.S.C. §119(a) the benefit of Korean Patent Application No. 10-2015-0067062 filed on May 14, 2015, the entire contents of which are incorporated herein by reference.

### BACKGROUND

(a) Technical Field

The present invention relates to a control system and method using weight estimation of a hybrid bus, more particularly, to a system and method for improving the fuel efficiency and the power performance based on the weight estimation of the hybrid bus.

(b) Description of the Related Art

Generally, the weight of a bus (for example, a passenger bus used for public transportation) significantly varies with the number of passengers. For example, when there are no passengers on a bus, the bus may weigh about 12 tons. However, when the bus is full, the weight of the bus may reach about 15.5 tons.

Since such weight difference significantly affects the fuel efficiency and the power performance, vehicle control according to weight is needed.

However, since the weight of a bus frequently changes due to passengers getting on or off the bus, it is difficult to monitor the weight of the bus in real-time. Particularly, in the case of a hybrid bus needing a State of Charge (SOC) strategy according to the weight, the real-time monitoring of the vehicle weight is further needed.

In this regard, a vehicle weight monitoring technology is being studied using a Tire Pressure Monitoring System (TPMS), but the investment cost and material cost of such technology is prohibitive.

Currently, there is no appropriate method to monitor the weight of a bus. In particular, in the case of a hybrid bus, even though power needed by an engine and motor are different and transmission time is different, the power of the engine and motor and the transmission time are controlled using a single map set regardless of the weight. Accordingly, there are limitations in fuel efficiency and power performance.

The above information disclosed in this Background section is only for enhancement of understanding of the background of the invention and therefore it may contain information that does not form the prior art that is already known in this country to a person of ordinary skill in the art.

### SUMMARY

The present invention provides a system and method using weight estimation of a hybrid bus, which estimates in real-time the entire weight of the hybrid bus according to the number of passengers using a transportation card reader in the hybrid bus, selects a power distribution map and a transmission map according to the estimated entire weight of the hybrid bus, controls a power split ratio of an engine and a motor by the selected map, and determines a transmission gear stage.

In one aspect, the present invention provides a control system using weight estimation of a hybrid bus, including: a transportation card reader generating a card tag signal whenever a passenger getting on and off the hybrid bus touches a transportation card to the transportation card reader; and a vehicle controller calculating a gross weight of the hybrid bus including an entire weight of passengers by detecting the number of passengers based on the card tag signal, selecting an optimal power distribution map based on the gross weight of the hybrid bus from a plurality of power distribution maps pre-configured in accordance with the gross weight of the hybrid bus, and controlling a power split ratio of an engine and a motor by the selected power distribution map.

In an exemplary embodiment, the plurality of power distribution maps may be configured to order the power split ratio of the engine and the motor in accordance with a required torque of a driver and a current vehicle speed, respectively.

In another exemplary embodiment, the vehicle controller may select an optimal transmission map based on the gross weight of the hybrid bus from a plurality of transmission maps pre-configured in accordance with the gross weight of the hybrid bus, and may determine a gear stage of a transmission by the selected transmission map.

In still another exemplary embodiment, the plurality of transmission maps may be configured to order the gear stage of the transmission in accordance with a required torque of a driver and a current vehicle speed.

In yet another exemplary embodiment, the card tag signal may include information on types of passengers getting on and off the hybrid bus, and the vehicle controller may accumulatively count the number of passengers remaining in the hybrid bus for each type based on the card tag signal and may calculate a entire weight of passengers by multiplying the numbers of passengers remaining in the hybrid bus for each type by the standard weights for each type.

In another aspect, the present invention provides a control method using weight estimation of a hybrid bus, including: counting a number of passengers in the hybrid bus for each type (of a plurality of types of passengers) based on a card tag signal of a transportation card reader; calculating a gross weight of the hybrid bus including an entire weight of passengers according to the number of passengers counted for each type; and selecting an optimal power distribution map based on the gross weight of the hybrid bus from a plurality of power distribution maps pre-configured in accordance with the gross weight of the hybrid bus and controlling a power split ratio of an engine and a motor by the selected power distribution map.

In an exemplary embodiment, the control method may include selecting an optimal transmission map based on the gross weight of the hybrid bus from a plurality of transmission maps pre-configured in accordance with the gross weight of the hybrid bus and determining a gear stage of a transmission by the selected transmission map.

In another exemplary embodiment, the counting of the number of passengers may include: accumulatively counting the number of passengers getting on the hybrid bus for each type based on the card tag signals of passengers getting on the hybrid bus; accumulatively counting the number of passengers getting off the hybrid bus for each type based on the card tag signals of passengers getting off the hybrid bus; and counting the number of passengers remaining in the hybrid bus for each type by subtracting the number of passengers getting off the hybrid bus from the number of passengers getting on the hybrid bus for each type.

In still another exemplary embodiment, the calculating of the gross weight of the hybrid bus may include calculating the entire weight of passengers by multiplying the number of passengers remaining in the hybrid bus for each type by the standard weights of passengers for each type and calculating the gross weight of the hybrid bus by summing up the entire weight of passengers and an empty vehicle weight without a passenger.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating a control system using weight estimation of a hybrid bus according to an embodiment of the present invention; and

FIG. 2 is a view illustrating a control method using weight estimation of a hybrid bus according to an embodiment of the present invention.

Reference numerals set forth in the Drawings includes reference to the following elements as further discussed below:

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” ^{an} and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present invention may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The above and other features of the invention are discussed infra.

Hereinafter, exemplary embodiments of the present invention will be described in detail with reference to the accompanying drawings so that those skilled in the art can easily carry out the present invention.

In this embodiment, in order to improve the fuel efficiency and the power performance of a hybrid electric vehicle, the weight of which is frequently changed, e.g. a bus, the performance and the fuel efficiency of the vehicle may be improved by estimating the number of passengers on board using a transportation card reader equipped in a vehicle, monitoring the entire weight of the vehicle in real-time, and utilizing the entire weight of the vehicle for vehicle control. As provided herein, a hybrid bus may serve as the “vehicle” or “hybrid electric vehicle,” but the invention is applicable to other types of vehicles, hybrid vehicles, or hybrid electric vehicles.

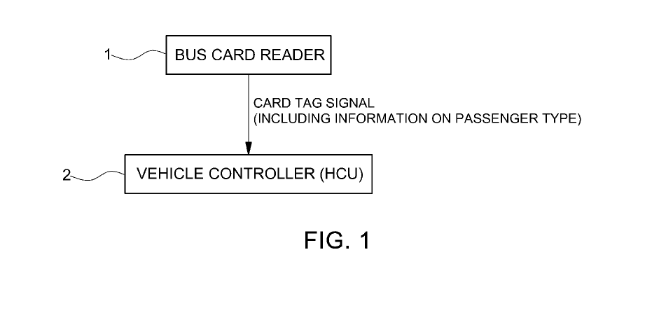

In FIG. 1, a control system may include a transportation card reader 1 that transmits a card tag signal of a passenger whenever a passenger gets on or off a vehicle, and a vehicle controller (Hybrid Control Unit; HCU) 2 that estimates an entire weight of the vehicle based on the card tag signal received from the transportation card reader 1 and utilizes the entire weight for vehicle control.

Generally, when a passenger gets on or off the vehicle (e.g., a hybrid electric bus), the passenger may touch the transportation card to the transportation card reader 1. Accordingly, the transportation card reader 1 may transmit a card tag signal of the passenger to the vehicle controller 2 whenever a passenger gets on or off the vehicle. In this case, the card tag signal transmitted may include information on the type of the passenger. For example, a plurality of types of passengers may be tracked (e.g., children, teenagers, and adults, although the types of passengers are not limited to these categories).

The vehicle controller 2 may calculate the number of passengers in the vehicle by accumulatively counting the card tag signals transmitted from the transportation card reader 1.

Specifically, the vehicle controller 2 may calculate the number of getting-on passengers by accumulatively counting the card tag signals of passengers received whenever passengers get on a vehicle, may calculate the number of getting-off passengers by accumulatively counting the card tag signals of passengers received whenever passengers get off the vehicle, and may subtract the number of getting-off passengers from the number of getting-on passengers to estimate the number of passengers actually remaining in the vehicle.

Here, the transportation card reader 1 may recognize each of the card tag signals of getting-on passengers and the card tag signals of getting-off passengers and transmit them. Each card tag signal may include information by which the type of passengers such as adults, teenagers, and children may be distinguished and recognized.

In general, the transportation card reader may be designed to identify transportation cards when the transportation cards are touched to the transportation card reader. Upon first tagging, the transportation card reader may recognize that a passenger having the corresponding transportation card gets on the vehicle, and upon second tagging of the same transportation card, the transportation card reader may recognize that the passenger having the corresponding transportation card gets off the vehicle.

The vehicle controller 2 may calculate the entire weight of passengers inside the vehicle based on the type of passengers remaining in the vehicle and the number of passengers for each type, and may sum up a prestored empty vehicle weight (weight of a vehicle body without a passenger) and the entire weight of passengers to obtain the gross weight of the vehicle.

In this case, the entire weight of passengers may be calculated by multiplying prestored standard weights for passenger types by the number of passengers for types. The standard weights of passenger types, for example, may include the average weights of male and female adults, the average weights of male and female teenagers, and the average weights of male and female children.

The vehicle controller 2 may variably control power distribution of an engine and a motor for driving of a vehicle in accordance with the gross weight of the vehicle which is calculated, and may determine the transmission gear stage.

For this, the vehicle controller 2 may prestore a plurality of power distribution maps ordering the power split ratio of the engine and the motor and a plurality of transmission maps ordering the gear stage of the transmission in accordance with the gross weight of a vehicle.

The vehicle controller 2 may select and determine optimal power distribution map and transmission map from the plurality of power distribution maps and the transmission maps, based on the gross weight of a vehicle which is calculated.

In this case, the respective power distribution maps may be configured to determine the power split ratio (output torque ratio) of the engine and the motor in accordance with current vehicle information (required torque of a driver and current vehicle speed). The respective transmission maps may be configured to determine the transmission gear stage in accordance with current vehicle information (required torque of a driver and current vehicle speed).

Hereinafter, a control method using weight estimation of a hybrid bus according to an embodiment of the present invention will be described based on the above-mentioned configuration.

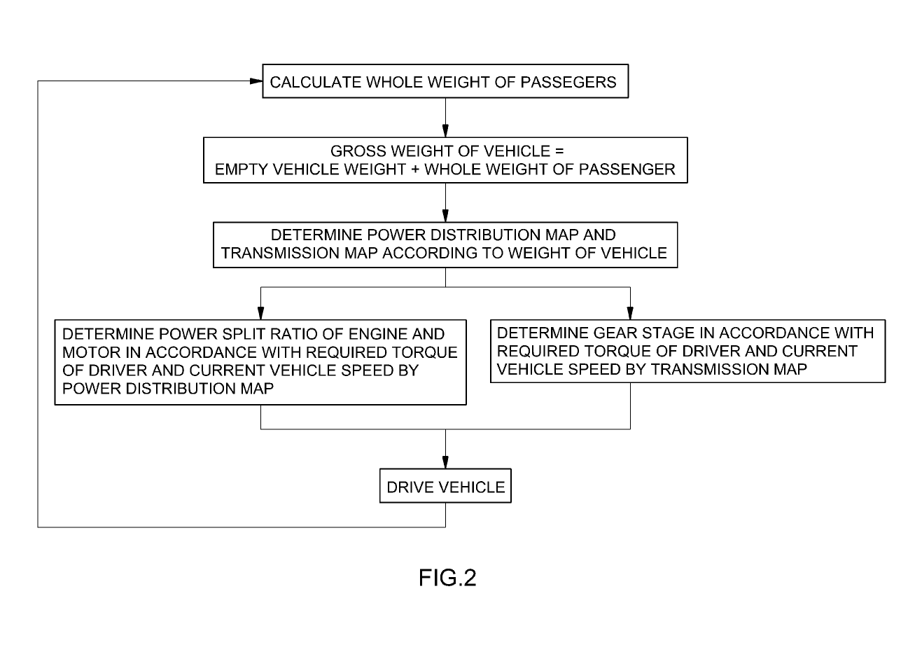

Referring to FIG. 2, card tag signals may be received from the transportation card reader 1 to accumulatively count the number of passengers in a vehicle for each type of a plurality of types of passengers (e.g., children, teenagers, and adults).

In this case, the number of passengers getting on a vehicle may be accumulatively counted for each type based on the card tag signals of passengers getting on the vehicle, and the number of passengers getting off the vehicle may be accumulatively counted for each type based on the card tag signal of passengers getting off the vehicle. Thereafter, the number of passengers getting off the vehicle may be subtracted from the number of passengers getting on the bus for each type to calculate the number of passengers remaining in the vehicle for each type of passengers.

Next, the entire weight of the passengers may be calculated by multiplying the number of passengers counted for each passenger type by the standard weight for each passenger type. The entire weight of passengers calculated may be added to the empty vehicle weight to calculate in real-time the gross weight of the vehicle.

Next, the optimal power distribution map may be selected and determined in accordance with the gross weight of the vehicle from the plurality of predetermined power distribution maps. The power split ratio (output torque ratio) of the engine and the motor may be controlled in accordance with the current vehicle information (required torque of driver and current vehicle speed) through the power distribution map that is determined. Also, power (torque) outputted from the engine and power (torque) outputted from the motor may be determined in accordance with the power split ratio.

Next, the optimal transmission map may be selected and determined in accordance with the gross weight of the vehicle from the plurality of predetermined transmission maps. The gear stage of the transmission may be determined in accordance with the current vehicle information (required torque of a driver and current vehicle speed) through the transmission map that is selected. The current gear stage of the transmission may be changed into the determined gear stage.

In this case, when the gear stage determined by the selected transmission map is identical to the current gear stage of the transmission, the gear stage of the transmission may not be changed. When the current gear stage is different from the determined gear stage, the gear stage of the transmission may be changed.

Based on the power (output) of the engine and the motor and the gear stage of the transmission which are determined as above, a vehicle may be driven.

Thus, the power split ratio of the engine and the motor and the gear stage of the transmission may be controlled in consideration of the gross weight of a vehicle. In this case, even if the current vehicle information (required torque of driver and current vehicle speed) is the same, the power split ratio of the engine and the motor may be changed in accordance with the gross weight of a vehicle, and the gear stage of the transmission may also be changed.

Thus, power distribution of the engine and the motor may be optimally controlled in accordance with the gross weight of a vehicle which is monitored in real-time, and the gear stage of the transmission may be optimally changed, thereby improving the fuel efficiency and the power performance of a hybrid electric vehicle.

The gear stage of the transmission may be changed using the optimal transmission map selected in accordance with the gross weight of a vehicle in a vehicle requiring the transmission map such as an automatic transmission vehicle or an automated manual transmission vehicle, thereby improving the fuel efficiency and the power performance.

According to an embodiment of the present invention, the fuel efficiency and the power performance of a hybrid bus may be improved by selecting a power distribution map and a transmission map based on the weight of the bus estimated and monitored in real-time, controlling a power split ratio of an engine and a motor by the selected map, and determining a transmission gear stage. Also, since the existing system can be utilized, a separate material cost and an investment cost are not needed.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A control system using weight estimation of a hybrid bus, comprising:
a transportation card reader configured to generate a card tag signal whenever a passenger getting on and off the hybrid bus touches a transportation card to the transportation card reader; and
a vehicle controller configured to calculate a gross weight of the hybrid bus comprising an entire weight of passengers by detecting the number of passengers based on the card tag signal, selecting an optimal power distribution map based on the gross weight of the vehicle from a plurality of power distribution maps pre-configured in accordance with the gross weight of the vehicle, and controlling a power split ratio of an engine and a motor by the selected power distribution map.

2. The control system of claim 1, wherein the plurality of power distribution maps are configured to order the power split ratio of the engine and the motor in accordance with a required torque of a driver and a current vehicle speed, respectively.

3. The control system of claim 1, wherein the vehicle controller selects an optimal transmission map based on the gross weight of the hybrid bus from a plurality of transmission maps pre-configured in accordance with the gross weight of the hybrid bus, and determines a gear stage of a transmission by the selected transmission map.

4. The control system of claim 3, wherein the plurality of transmission maps are configured to order the gear stage of the transmission in accordance with a required torque of a driver and a current vehicle speed.

5. The control system of claim 1, wherein the card tag signal comprises information on types of passengers getting on and off the vehicle, and the vehicle controller accumulatively counts the number of passengers remaining in the vehicle for each type based on the card tag signal and calculates the entire weight of passengers by multiplying the number of passengers remaining in the vehicle for each type by the standard weights for each type.

6. A control method using weight estimation of a hybrid bus, comprising:
counting a number of passengers in the hybrid bus for each type of a plurality of types of passengers based on a card tag signal of a transportation card reader;
calculating a gross weight of a vehicle comprising an entire weight of passengers according to the number of passengers counted for each type; and
selecting an optimal power distribution map based on the gross weight of the vehicle from a plurality of power distribution maps pre-configured in accordance with the gross weight of a vehicle and controlling a power split ratio of an engine and a motor by the selected power distribution map.

7. The control method of claim 6, comprising selecting an optimal transmission map based on the gross weight of the vehicle from a plurality of transmission maps pre-configured in accordance with the gross weight of the vehicle and determining a gear stage of a transmission by the selected transmission map.

8. The control method of claim 6, wherein the counting of the number of passengers comprises:
accumulatively counting the number of passengers getting on the vehicle for each type based on the card tag signals of passengers getting on the vehicle;
accumulatively counting the number of passengers getting off the vehicle for each type based on the card tag signals of passengers getting off the vehicle; and
counting the number of passengers remaining in the vehicle for each type by subtracting the number of passengers getting off the vehicle from the number of passengers getting on the vehicle for each type.

9. The control method of claim 6, wherein the calculating of the gross weight of the vehicle comprises calculating the entire weight of passengers by multiplying the number of passengers remaining in the vehicle for each type by the standard weights of passengers for each type and calculating the gross weight of the vehicle by summing up the entire weight of passengers and an empty vehicle weight without any passengers.
